(19) United States
(12) Patent Application Publication
(10) Pub. No.: US 2005/0267971 A1
(43) Pub. Date: Dec. 1, 2005

(54) System and method of using DNA for linking to network resources

(76) Inventor: Charles W. Fritz, Fort Myers, FL (US)

Correspondence Address: ANTHONY R. BARKUME, 20 GATEWAY LANE, MANORVILLE, NY, 11949, US

(21) Appl. No.: 11/097,989

(22) Filed: Apr. 1, 2005

Related U.S. Application Data
(60) Provisional application No. 60/558,675, filed on Apr. 1, 2004.

(51) Int. Cl. G06F 15/173

(52) U.S. Cl. 709/225

(57) ABSTRACT

A method and system for utilizing a DNA sequence embedded or associated with a product or living organism for linking a user computer to an associated online resource. The system comprises a reading device that is adapted to extract a DNA sequence from an associated token or product, and a client computer device that is associated with the reading device. The client computer device, for example a hand held reader with wireless network access, will access the DNA sequence and formulate a query that includes all or a part of the DNA sequence. The query is then transmitted to a routing server computer that is interconnected to the network (such as the Internet). The routing server computer accepts the query and accesses a database, which may be local or distributed amongst several computers on the network. The DNA sequence in the query is used to lookup an associated information server address (e.g. URL) that has been previously associated with that DNA sequence. The information server address is then returned back to the client computer device, and the client computer device will use that address to access the information server over the network and obtain whatever resource is associated with that address.

### CROSS REFERENCE TO RELATED APPLICATION

This application is based on and claims priority from co-pending U.S. Provisional Application Ser. No. 60/558,675, which was filed on Apr. 1, 2004, which is incorporated by reference herein.

### BACKGROUND OF THE INVENTION

This application relates to the use of DNA for linking to resources residing on an information server in a networked computing environment such as the Internet.

Technologies have evolved that provide for the unique or quasi-unique identification of goods for security as well as other purposes. For example, secure methods exist that provide for the use of a unique mark containing a product control code printed in an invisible ink that includes an ultraviolet (UV) ink and an infrared (IR) ink (U.S. Pat. No. 6,536,672). By employing appropriate reading technology, the code may be verified to determine the authenticity of the associated product.

An anti-counterfeit DNA security access system is provided by Applied DNA Sciences (www.adnas.com), which is a biotechnology system comprised of a microchip and accompanying Chip Reader. Combinations of plant DNA are embedded into a non-silicon based microchip, which can be used to authenticate numerous products. For example, this microchip may be embedded into any number of products, and with the associated DNA chip reader, the product can be authenticated by reading the biological DNA chip data sequence. Thus, DNA may be embedded into certain products and inks and be used to uniquely identify the carrier.

Under certain contexts, it is desirable to be able to link a physical token to an online source of information over a computer network. Although the physical token (in particular one identified by embedded DNA) may be fixed, the information with which it is linked may vary at any time. Thus, an actual link to the resource is desired.

It is also desired to be able to provide a link to an online resource where the location (i.e. URL) of the resource may change at any given time.

What is desired therefore is a system that may be utilized by end users or clients to retrieve information by allowing the client device to read an embedded DNA code into a client computing device to look up information from a destination address associated with the code. Preferably the computing device is connected to a network of computers such that DNA read from the token may be used to lookup information about that identified token. This methodology may be applied to any item that requires identification at any point in the distribution channel, such that extended content may be associated with it.

In addition, it is desired to be able to obtain a DNA sample from a living organism such as a human being and obtain access to an online resource in the same manner.

### SUMMARY OF THE INVENTION

Provided is a method and system for utilizing a DNA sequence embedded or associated with a product or living organism for linking a user computer to an associated online resource. The systems comprises a reading device that is adapted to extract a DNA sequence from an associated token, product, or living organism and a client computer device that is associated with the reading device. The client computer device, for example a hand held reader with wireless network access, will access the DNA sequence and formulate a query that includes all or a part of the DNA sequence. The query is then transmitted to a routing server computer that is interconnected to the network (such as the Internet). The routing server computer accepts the query and accesses a database, which may be local or distributed amongst several computers on the network. The DNA sequence in the query is used to lookup an associated information server address (e.g. URL) that has been previously associated with that DNA sequence. The information server address is then returned back to the client computer device, and the client computer device will use that address to access the information server over the network and obtain whatever resource is associated with that address.

### BRIEF DESCRIPTION OF THE DRAWING

FIG. 1 is a block diagram of the preferred embodiment of the present invention;

FIG. 2 is a flowchart of the operation of the present invention.

### DETAILED DESCRIPTION OF THE PREFERRED EMBODIMENT

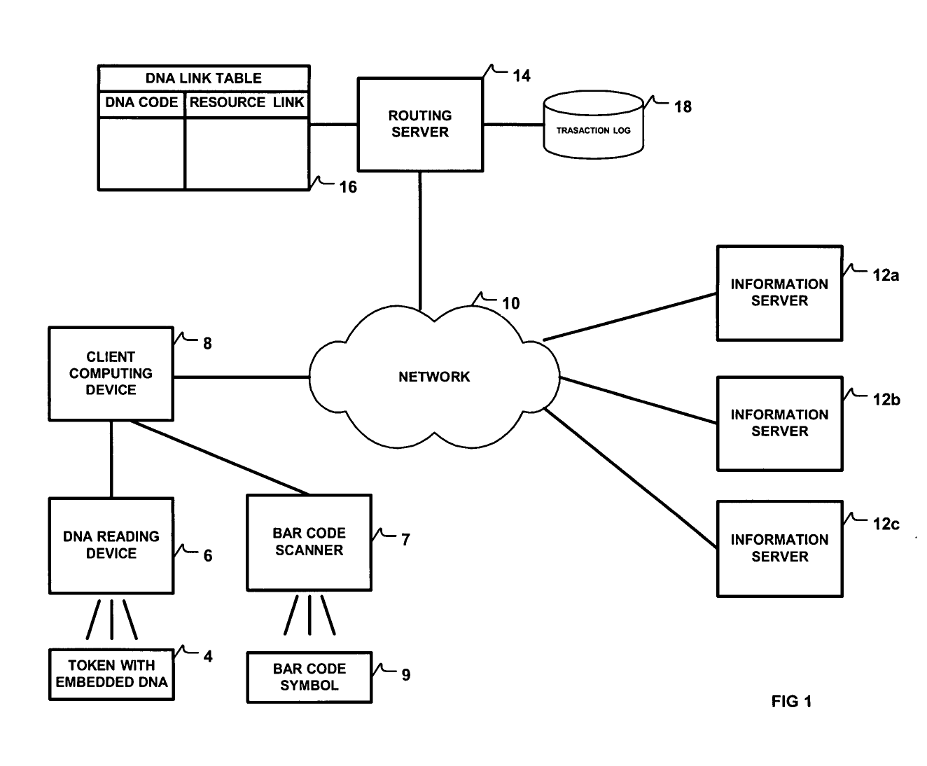

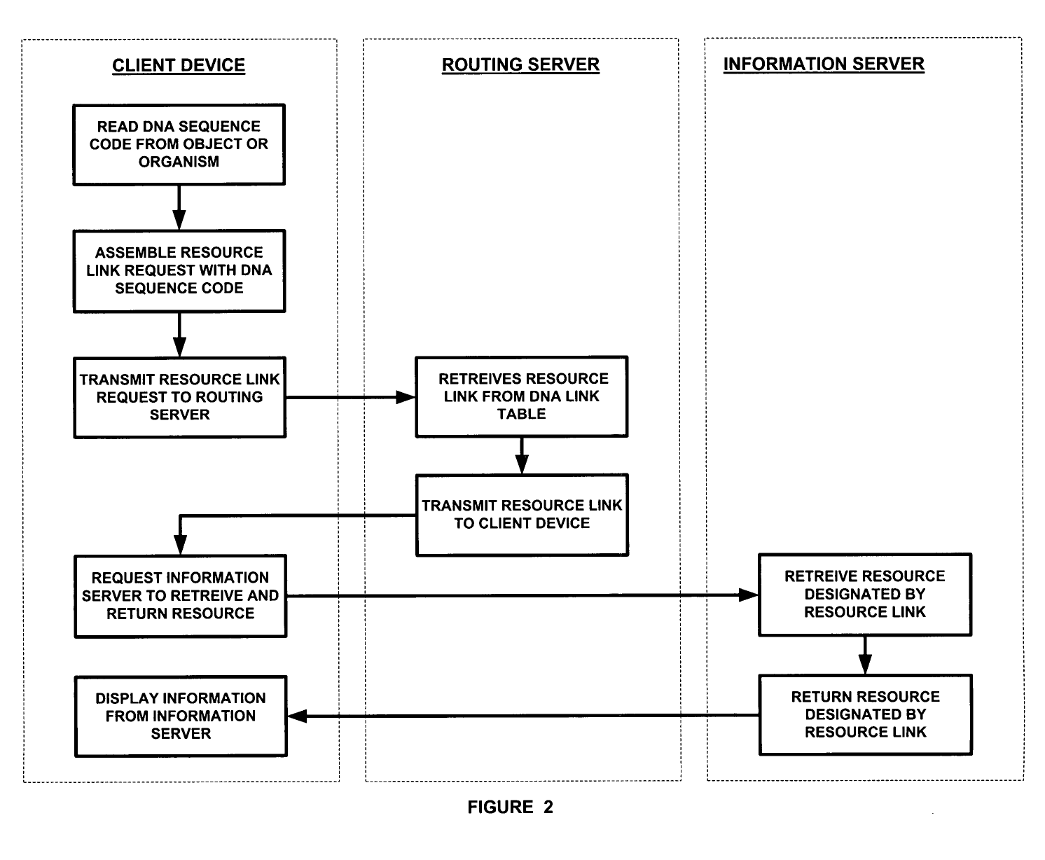

Referring to FIGS. 1 and 2, a block diagram of the system and flowchart of the operation of the preferred embodiment of the present invention is illustrated. The basic system includes a client computing device 8 interconnected to a computer network 10, preferably as a wide area network (WAN) such as the Internet. Virtually any type of computer network may be used by the present invention. However, by using a WAN such as the Internet, the system designer is able to utilize information resources located anywhere on the network, which in the case of the Internet would be anywhere in the world. In the alternative, a local area network (LAN) could also be used, but the location of the information server computers would be constrained physically to the LAN's topology.

The client computing device 8 may be any type of device that provides for interconnectivity to the associated network 10, such as a wireless link (e.g. WiFi, BLUETOOTH, wireless cellular, etc.) or a standard wired connection such as an Ethernet connection to a router, which in turn is connected to the Internet by techniques well known in the art. The client computing device 8 also will have application-specific functionality suitable for the desired application, such as a display screen when information must be viewed by the user. For example, a user computing device may have a display and web browser software for displaying a web page to the user. The application-specific functionality may be an LCD text display, or it may be a sounder device, etc.

The client computing device must also have an interface or input means capable of exchanging information with a DNA reading device 6 as shown in FIG. 1. The DNA reading device 6 and client computing device 8 may be an integrated unit, or the two components may be separate and connected by an input/output port as well known in the art. For example, the client computing device 8 may be a personal computer, and the DNA reading device 6 may be connected to the personal computer via a USB port as well known in the art.

The DNA reading device may be any type of instrument as known in the art that is enabled to analyze DNA and extract information such as a DNA code sequence from the DNA for analysis and review. Such DNA reading devices are known and need not be explained in further detail herein.

The client computing device will also have a processor means, as well known in the art, which will be adapted (programmed) in order to assemble a resource link request that includes at least part of the DNA sequence code obtained from the DNA reading device. The client computing device will use the resource link request to request a resource link associated with the DNA sequence code from a routing server as described herein.

A routing server computer 14 is also shown in FIG. 1 interconnected to the network 10. The routing server 14 will have a database 16 or set of tables that link a DNA code sequence to an associated information resource address, such as a URL or simply the name or address of the associated information server. The routing server 14 is configured to interface with the network 10 as well known in the art.

The routing server 14 is adapted to receive a resource link request from the client computing device 8, extract DNA code information from the routing request, and then use the DNA code information to lookup an associated resource link (e.g. URL) from its DNA link database 16. The routing server 14 will then return the resource link URL to the client computing device 8, for example in the form of a redirect command that will cause the client computing device 8 to access the information server 12a automatically. The routing server 14 may also have a transaction log 18 which will track each request by a client computing device 8, the DNA code sequence in the query, as well as the URL returned from the database 16 to the client computing device 8.

Also shown in FIG. 1 are numerous information server computers 12a, 12b, 12c, each with a unique address on the network. The information server computers store information resources that will be returned to the client computing device 8. The information servers may also perform functions and return results to the client computing device (e.g. authentication, etc.). When a request for information is made by the client computing device 8 (as directed by the routing server 14), then the information server accesses the requested information and returns it the client computing device 8.

Reference is made to U.S. Pat. No. 5,978,773, SYSTEM AND METHOD FOR USING AN ORDINARY ARTICLE OF COMMERCE TO ACCESS A REMOTE COMPUTER, owned by the assignee of the present application. In the '773 patent, the specification of which is incorporated by reference herein, a system and method is described for using identification codes found on ordinary articles of commerce to access remote computers on a network. In accordance with one embodiment of that invention, a computer is provided having a database that relates Uniform Product Code (UPC) numbers to Internet network addresses (URLs). To access an Internet resource relating to a particular product, a user enters the product's UPC symbol manually, by swiping a bar code reader over the UPC symbol, or via other suitable input means. The database retrieves the URL corresponding to the UPC code. This location information is then used to access the desired resource. The teachings of the '773 patent for accessing remote resources with bar code symbols may be implemented in the present invention in a novel way to allow DNA sequence codes to be used to access remote resources as described herein.

The following is an example of the operation of the present invention. A user presents a token 4 that is embedded with DNA as known in the art. The DNA reading device is activated and reads the DNA code sequence from the token. The client computing device 8 receives the DNA code sequence and generates a request message that is transmitted over the network 10 to the routing server 14. The routing server 14 looks up the DNA code received from the client computing device, grabs the associated resource link from the database 16, and then returns the resource link to the client computing device via the network 10. The client computing device 8 then uses the resource link to communicate with the information server 12a, 12b, or 12c that is indicated in the resource link information. The information server then returns the requested resource to the client computing device 8.

A DNA embedded token may be any physical object from which a DNA sequence may be extracted or read. For example, it is known in the prior art that combinations of plant DNA may be embedded into a non-silicon based microchip, which can be used to authenticate products. For example, a DNA chip can be embedded into a product, and the product may be authenticated by reading the biological DNA chip sequence. By using this technology under the present invention, a product may have information stored on an information server and the routing server would be programmed to link the client computing device to the information server as described above.

In addition, DNA may be added to virtually any water based ink. In this case, there are two types of DNA reading; instant and via a reader. The instant reading is similar to other solutions that are known in the prior art, wherein there is a special liquid that when dropped on the paper will cause the paper to turn a different color. When the clear liquid is wiped away, the paper reverts back to the original.

In the prior art, it has been found that plant DNA may be applied or embedded into media such as ink, paint, glue, polymers, labels, as well as microchips as described above. The prior art uses this to authenticate and distinguish genuine products from counterfeits. DNA technology in the prior art may also be integrated with products such as pharmaceuticals, textiles, aviation, auto parts, software, hardware, consumer electronics, agriculture, food, wine, fashion labels, jewelry, antiques, fine arts, and other applications.

Thus, products having such embedded DNA may be linked to a resource that can be used to store information about that product. By linking the physical object to the information resource through the resolution server, the present invention provides for real-time access to information about that object that may be maintained by any provider, as long as that provider has linked the information server to the DNA code as described herein.

In a similar manner, the present invention may be adapted to obtain a DNA sample from a living organism such as a human being and utilize that DNA sample to link to an associated online resource as described herein. One notable application for this invention would be for law enforcement agencies as an aid in identifying crime suspects. A DNA link table may be assembled, linking DNA signatures information to an online address that contains information about the person having that DNA. Various information servers may be assembled with databases that store records of information about persons, such as name, address, contact information, prior criminal activity, images such as photographs, police records, etc. Due to the extremely large amounts of information this entails, it would be desirable to have a number of information servers managed by various entities such as local law enforcement agencies (e.g. the New York Police Department), federal agencies (e.g. the F.B.I) and international agencies (e.g. Interpol). Each agency would manage its own database and provide resource addresses (such as URLs) to the routing server, wherein each person would have a record in the information server database and an associated URL. The routing server would then store in the DNA link table a record for each person, having that person's DNA sequence and the information server URL provided by the agency for that person.

By having multiple information servers that are not in the same database as the DNA link table, various problems are alleviated, such as scaling and privacy concerns. Scaling is achieved on a technical level by spreading out the information amongst many information servers rather than a single server, with different servers managed by different agencies as described above. As a person's record changes (e.g. further arrests are made, or expunged, etc.), that agency can revise that person's record in the database without having to access the routing server DNA link table. Thus, each agency can easily manage its database locally.

The routing server in this embodiment will act as a national or even international clearinghouse for linking DNA sequences to records contained in the local information server(s). When a police agency collects DNA evidence from a crime scene, the DNA sequence may be input into the client computing device and transmitted over the network to the routing server. The routing server will query the DNA link table and obtain one or more URLs linked to that DNA sequence. The URLs will be returned to the client device and the client device will connect with the information server(s) indicated in the URL(s) in order to retrieve the resources associated with the URL(s) from the information server(s).

In an alternative embodiment related to product identification, a bar code symbol 9 may be used advantageously with the DNA embedded in a product or its marking as described above. Since the actual presence of DNA embedded in a product may be difficult to ascertain, the bar code symbol 9 may be encoded so as to instruct a user that DNA may be read from the object for further information gathering and/or verification. Thus, a bar code 9 on a product may have typical information encoded in it, such as manufacturer name and product identification, but it may not be specifically tailored for that particular individual product. That is, the same bar code may be found on all similar products, with no other way to distinguish them. By including a reference in the bar code to the presence of DNA information, the user that scans the bar code symbol 9 with an associated bar code scanner 7 would be alerted that he should also read the DNA embedded in the product and obtain further information about that particular item by linking to an information server as described above.

1. A method for using a DNA sequence code for obtaining an online resource comprising the steps of:
a. reading a DNA sequence code from a physical object;
b. sending from a client computing device a resource link request over a computer network to a routing server, the resource link request comprising at least part of the DNA sequence code read from the physical object;
c. the routing server retrieving a resource link associated with the at least part of the DNA sequence code from the resource link request, the resource link indicating an information server located on the network;
d. the routing server returning the retrieved resource link to the client computing device;
e. the client computing device utilizing the resource link from the routing server to communicate over the network with an information server indicated by the resource link;
f. the information server indicated by the resource link returning information to the client computing device.

2. The method of claim 1 wherein the client computing device is a personal computer.

3. The method of claim 1 wherein the client computing device is a hand held portable computer.

4. The method of claim 1 wherein the network is the Internet.

5. The method of claim 1 further comprising the steps of
scanning a bar code associated with the physical object to obtain bar code data, decoding the bar code data, and reading the DNA sequence from the physical object only when the decoded bar code data indicates that DNA information is present on the object.

6. A system comprising:
a. DNA sequencing reader adapted to obtain a DNA sequence code from a physical object;
b. a client computing device coupled to the DNA sequencing reader and interconnected to a computer network, comprising:
i. input means for obtaining from the DNA sequencing reader the DNA sequence code obtained from the physical object;
ii. processing means for assembling a resource link request comprising at least part of the DNA sequence code read from the physical object;
iii. transmission means for transmitting the resource link request over a computer network to a routing server,
c. a routing server interconnected to a computer network, comprising:
i. receiving means for receiving the resource link request transmitted by the client computing device;
ii. a memory for storing a DNA link table comprising a plurality of data records that associate at least part of a DNA sequence code with at least one resource link that specifies the location of a resource on an information server interconnected to the computer network;
iii. processing means for retrieving at least one resource link associated with a DNA sequence code obtained from a resource link request received from the client computing device;
iv. transmission means for transmitting the retrieved resource link to the client computing device;
wherein the client computing device further comprises means for receiving the resource link from the routing server and communicating with the information server specified in the resource link;
d. an information server interconnected to the computer network, comprising:
i. means for receiving the resource link from the client computing device;
ii. a memory for storing an information resource associated with the resource link;
iii. means for retrieving from the memory the information associated with the resource link;
iv. transmission means for transmitting the retrieved information resource to the client computing device;
wherein the client computing device further comprises display means for displaying the information resource received from the information server via the computer network.

7. The system of claim 6 further comprising a bar code scanner interconnected to the client computing device for reading a bar code symbol and causing the client computing device to obtain a DNA sequence code from the DNA sequencing reader and retrieve an associated information resource from an information server based on data decoded from the bar code symbol.
